(19) United States
(12) Patent Application Publication
(10) Pub. No.: US 2008/0101410 A1
(43) Pub. Date: May 1, 2008

(54) Techniques for managing output bandwidth for a conferencing server

(75) Inventors: Warren V. Barkley, Mill Creek, WA (US); Philip A. Chou, Bellevue, WA (US); Regis J. Crinon, Camas, WA (US); Tim Moore, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/586,171

(22) Filed: Oct. 25, 2006

(51) Int. Cl. H04L 12/16; H04J 3/24

(52) U.S. Cl. 370/473; 370/260

(57) ABSTRACT

Techniques for managing output bandwidth for a conferencing server are described. An apparatus may include a receiver to receive input video streams at first bit rates from multiple client terminals. The apparatus may include a rate allocation module to allocate an output bit rate for an output video stream corresponding to each input video stream based on distortion rate information where a total output bit rate for all output video streams is equal to or less than a total output bit rate budget for a conference server. The apparatus may include a video transrating module to reduce the first bit rate to a second bit rate for one or more input video streams in accordance with the allocations to create the output video streams. Other embodiments are described and claimed.

### BACKGROUND

Multimedia conference calls typically involve communicating voice, video, and/or data information between multiple endpoints. With the proliferation of data networks, multimedia conferencing is migrating from traditional circuit-switched networks to packet networks. To establish a multimedia conference call over a packet network, a conferencing server typically operates to coordinate and manage the conference call. The conferencing server receives a video stream from a sending participant and multicasts the video stream to other participants in the conference call. Consequently, at any given point in time during a conference call, the conferencing server may be receiving multiple input video streams and sending multiple output video streams that may substantially affect computing or communication efficiency. Moreover, the multiple input video streams may have varying bit rates thereby creating an even greater resource burden. Accordingly, a conferencing server may have some difficulties in efficiently communicating the varying video streams to the other participants in the conference call.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to techniques to improve conference server operations during a multimedia conference call. Some embodiments in particular may be directed to techniques for managing output bandwidth for a conferencing server. For example, some embodiments may attempt to selectively and dynamically reduce the varying bit rates for one or more input video streams received by a conferencing server to fit a bandwidth constraint for the conferencing server. As a result, utilization of the available computing and/or communication resources for the conferencing server may be improved, while still allowing higher bit rates for the input video streams in view of the cross-stream design constraints.

In one embodiment, for example, an apparatus such as a conferencing server may include a receiver arranged to receive input video streams at first bit rates from multiple client terminals. The conferencing server may further include a rate management module having a rate allocation module and a video transrating module. The rate allocation module may be arranged to allocate an output bit rate for an output video stream corresponding to each input video stream based on distortion rate information. The rate allocation module may use an allocation technique that ensures a total allocated output bit rate for all output video streams is equal to or less than a bandwidth constraint for the conference server. An example of a bandwidth constraint may include a total output bit rate budget for the conference server, although the embodiments are not limited to this example. The video transrating module may include a video encoder and/or video transcoder to reduce an overall input bit rate for the multiple video streams by reducing a first bit rate to a second bit rate for each input video stream in accordance with the allocations to create the output video streams. Other embodiments are described and claimed.

### BRIEF DESCRIPTION OF THE DRAWINGS

FIG. 1 illustrates an embodiment for a multimedia conference system.

FIG. 2 illustrates an embodiment for a computing environment.

FIG. 3 illustrates an embodiment for a rate management module.

FIG. 4 illustrates an embodiment for a logic flow.

### DETAILED DESCRIPTION

Various embodiments are directed to rate management techniques for a conferencing server (or other network device used in a conference call) to improve efficient utilization of the total output bit rate budget for the conferencing server. For example, assume each client terminal that sends a video stream to conferencing server 102 encodes the data stream such that each frame (or group of frames) is independently scalable, and contains distortion rate information as side information. The distortion rate information is a representation of a function D(R), representing the distortion, or conversely the quality, of the frame as a function of the number of bits used to encode the frame. The rate management module examines the distortion rate information associated with the current frame of each outgoing data stream, and after appropriately weighting the distortion rate information, allocates bits to the outgoing data streams in accordance with an output bit rate allocation algorithm. An example of weighting operations may include multiplying the distortion component by the importance of a given video stream, as well as other criteria.

In various embodiments, the rate management module may implement an output bit rate allocation algorithm that is designed to allocate bits in increments of potentially varying sizes. The size of each increment may vary, and an example of an increment size may include one bit at a time. The rate management module assigns each increment to the outgoing data stream that has the greatest decrease in distortion or increase in quality per bit, up to the maximum number of bits that can be allocated for that frame. The number of bits that can be allocated is limited by one or more assignment limitation parameters, including: (1) the number of bits to which the frame was originally encoded; (2) the maximum bit rate supportable by a client terminal consuming the outgoing data stream; and (3) the maximum overall output bit rate supportable by the conferencing server. This process stops when no more bits can be allocated to any outgoing data streams. Then the process is repeated for the next frame or group of frames.

The rate matching techniques of the various embodiments may provide several advantages. In some embodiments, for example, it is possible for a conferencing server to make full use of its output capacity at all times without exceeding output capacity. Further, a conferencing server may determine an efficient division of the output capacity between the participants at all times to improve the average quality to each participant. In addition, a conferencing server may admit new participants while only marginally affecting the other participants. These and other advantages can be realized without collaboration among the video encoders, which is generally not possible when the participants are distributed. These advantages can also be realized while reducing the need for video transcoding at conferencing server, which is generally computationally expensive, in those cases where the participants use video encoders implementing scalable coding techniques.

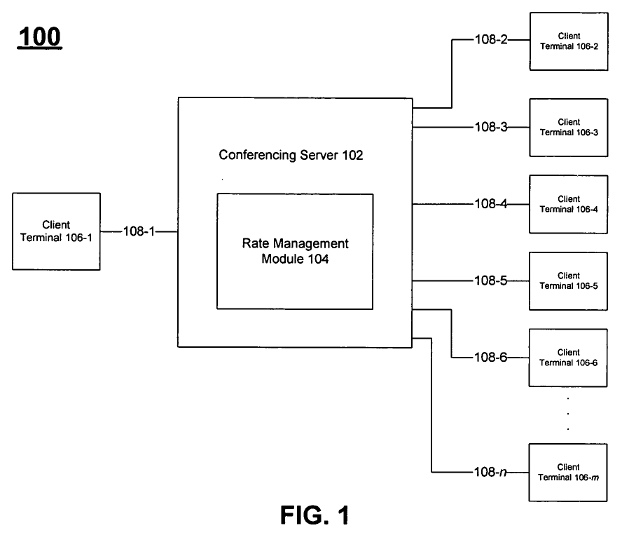

FIG. 1 illustrates a block diagram for a multimedia conferencing system 100. Multimedia conferencing system 100 may represent a general system architecture suitable for implementing various embodiments. Multimedia conferencing system 100 may comprise multiple elements. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although multimedia conferencing system 100 as shown in FIG. 1 has a limited number of elements in a certain topology, it may be appreciated that multimedia conferencing system 100 may include more or less elements in alternate topologies as desired for a given implementation. The embodiments are not limited in this context.

In various embodiments, multimedia conferencing system 100 may be arranged to communicate, manage or process different types of information, such as media information and control information. Examples of media information may generally include any data representing content meant for a user, such as voice information, video information, audio information, image information, textual information, numerical information, alphanumeric symbols, graphics, and so forth. Control information may refer to any data representing commands, instructions or control words meant for an automated system. For example, control information may be used to route media information through a system, to establish a connection between devices, instruct a device to process the media information in a predetermined manner, and so forth.

It is worthy to note that although some embodiments may discuss the communication and processing of media information in the form of video information or video streams, it may be appreciated that any type of media information in media streams may be used as well. For example, various embodiments may implement various rate matching techniques to communicate and process media information in the form of audio information or audio streams, and other types of media information as well. The embodiments are not limited in this context.

In various embodiments, multimedia conferencing system 100 may include a conferencing server 102. Conferencing server 102 may comprise any logical or physical entity that is arranged to manage or control a multimedia conference call between client terminals 106-1-m. In various embodiments, conferencing server 102 may comprise, or be implemented as, a processing or computing device, such as a computer, a server, a router, a switch, a bridge, and so forth. A specific implementation for conferencing server 102 may vary depending upon a set of communication protocols or standards to be used for conferencing server 102. In one example, conferencing server 102 may be implemented in accordance with the International Telecommunication Union (ITU) H.323 series of standards and/or variants. The H.323 standard defines a multipoint control unit (MCU) to coordinate conference call operations. In particular, the MCU includes a multipoint controller (MC) that handles H.245 signaling, and one or more multipoint processors (MP) to mix and process the data streams. In another example, conferencing server 102 may be implemented in accordance with the Internet Engineering Task Force (IETF) Multiparty Multimedia Session Control (MMUSIC) Working Group Session Initiation Protocol (SIP) series of standards and/or variants. SIP is a proposed standard for initiating, modifying, and terminating an interactive user session that involves multimedia elements such as video, voice, instant messaging, online games, and virtual reality. Both the H.323 and SIP standards are essentially signaling protocols for Voice over Internet Protocol (VoIP) or Voice Over Packet (VOP) multimedia conference call operations. It may be appreciated that other signaling protocols may be implemented for conferencing server 102, however, and still fall within the scope of the embodiments. The embodiments are not limited in this context.

In various embodiments, multimedia conferencing system 100 may include one or more client terminals 106-1-m to connect to conferencing server 102 over one or more communications links 108-1-n, where m and n represent positive integers that do not necessarily need to match. For example, a client application may host several client terminals each representing a separate conference at the same time. Similarly, a client application may receive multiple video streams. For example, video streams from all or a subset of the participants may be displayed as a mosaic on the participant's display with a top window with video for the current active speaker, and a panoramic view of the other participants in other windows. Client terminals 106-1-m may comprise any logical or physical entity that is arranged to participate or engage in a multimedia conference call managed by conferencing server 102. Client terminals 106-1-m may be implemented as any device that includes, in its most basic form, a processing system including a processor and memory (e.g., memory units 110-1-p), one or more multimedia input/output (I/O) components, and a wireless and/or wired network connection. Examples of multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of client terminals 106-1-m may include a telephone, a VoIP or VOP telephone, a packet telephone designed to operate on a Packet Switched Telephone Network (PSTN), an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. The embodiments are not limited in this context.

Depending on a mode of operation, client terminals 106-1-m may be referred to as sending client terminals or receiving client terminals. For example, a given client terminal 106-1-m may be referred to as a sending client terminal when operating to send a video stream to conferencing server 102. In another example, a given client terminal 106-1-m may be referred to as a receiving client terminal when operating to receive a video stream from conferencing server 102, such as a video stream from a sending client terminal, for example. In the various embodiments described below, client terminal 106-1 is described as a sending client terminal, while client terminals 106-2-m are described as receiving client terminals, by way of example only. Any of client terminals 106-1-m may operate as a sending or receiving client terminal throughout the course of conference call, and frequently shift between modes at various points in the conference call. The embodiments are not limited in this respect.

In various embodiments, multimedia conferencing system 100 may comprise, or form part of, a wired communications system, a wireless communications system, or a combination of both. For example, multimedia conferencing system 100 may include one or more elements arranged to communicate information over one or more types of wired communications links. Examples of a wired communications link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. Multimedia conferencing system 100 also may include one or more elements arranged to communicate information over one or more types of wireless communications links. Examples of a wireless communications link may include, without limitation, a radio channel, infrared channel, radio-frequency (RF) channel, Wireless Fidelity (WiFi) channel, a portion of the RF spectrum, and/or one or more licensed or license-free frequency bands.

Multimedia conferencing system 100 also may be arranged to operate in accordance with various standards and/or protocols for media processing. Examples of media processing standards include, without limitation, the Society of Motion Picture and Television Engineers (SMPTE) 421M (“VC-1”) series of standards and variants, VC-1 implemented as MICROSOFT® WINDOWS®E MEDIA VIDEO version 9 (WMV-9) series of standards and variants, Digital Video Broadcasting Terrestrial (DVB-T) broadcasting standard, the ITU/IEC H.263 standard, Video Coding for Low Bit rate Communication, ITU-T Recommendation H.263v3, published November 2000 and/or the ITU/IEC H.264 standard, Video Coding for Very Low Bit rate Communication, ITU-T Recommendation H.264, published May 2003, Motion Picture Experts Group (MPEG) standards (e.g., MPEG-1, MPEG-2, MPEG-4), and/or High performance radio Local Area Network (HiperLAN) standards. Examples of media processing protocols include, without limitation, Session Description Protocol (SDP), Real Time Streaming Protocol (RTSP), Real-time Transport Protocol (RTP), Synchronized Multimedia Integration Language (SMIL) protocol, and/or Internet Streaming Media Alliance (ISMA) protocol. The embodiments are not limited in this context.

In one embodiment, for example, conferencing server 102 and client terminals 106-1-m of multimedia conferencing system 100 may be implemented as part of an H.323 system operating in accordance with one or more of the H.323 series of standards and/or variants. H.323 is an ITU standard that provides specification for computers, equipment, and services for multimedia communication over networks that do not provide a guaranteed quality of service. H.323 computers and equipment can carry real-time video, audio, and data, or any combination of these elements. This standard is based on the IETF RTP and RTCP protocols, with additional protocols for call signaling, and data and audiovisual communications. H.323 defines how audio and video information is formatted and packaged for transmission over the network. Standard audio and video coders/decoders (codecs) encode and decode input/output from audio and video sources for communication between nodes. A codec converts audio or video signals between analog and digital forms. In addition, H.323 specifies T.120 services for data communications and conferencing within and next to an H.323 session. The T.120 support services means that data handling can occur either in conjunction with H.323 audio and video, or separately, as desired for a given implementation.

In accordance with a typical H.323 system, conferencing server 102 may be implemented as an MCU coupled to an H.323 gateway, an H.323 gatekeeper, one or more H.323 terminals 106-1-m, and a plurality of other devices such as personal computers, servers and other network devices (e.g., over a local area network). The H.323 devices may be implemented in compliance with the H.323 series of standards or variants. H.323 client terminals 106-1-m are each considered “endpoints” as may be further discussed below. The H.323 endpoints support H.245 control signaling for negotiation of media channel usage, Q.931 (H.225.0) for call signaling and call setup, H.225.0 Registration, Admission, and Status (RAS), and RTP/RTCP for sequencing audio and video packets. The H.323 endpoints may further implement various audio and video codecs, T.120 data conferencing protocols and certain MCU capabilities. Although some embodiments may be described in the context of an H.323 system by way of example only, it may be appreciated that multimedia conferencing system 100 may also be implemented in accordance with one or more of the IETF SIP series of standards and/or variants, as well as other multimedia signaling standards, and still fall within the scope of the embodiments. The embodiments are not limited in this context.

In general operation, multimedia conference system 100 may be used for multimedia conference calls. Multimedia conference calls typically involve communicating voice, video, and/or data information between multiple end points. For example, a public or private packet network may be used for audio conferencing calls, video conferencing calls, audio/video conferencing calls, collaborative document sharing and editing, and so forth. The packet network may also be connected to the PSTN via one or more suitable VoIP gateways arranged to convert between circuit-switched information and packet information. To establish a multimedia conference call over a packet network, each client terminal 106-1-m may connect to conferencing server 102 using various types of wired or wireless communications links 108-1-n operating at varying connection speeds or bandwidths, such as a lower bandwidth PSTN telephone connection, a medium bandwidth DSL modem connection or cable modem connection, and a higher bandwidth intranet connection over a local area network (LAN), for example.

In various embodiments, conferencing server 102 may establish and manage a conference call between client terminals 106-1-m. Conferencing server 102 operates as a central server that controls and distributes media information in the conference. It handles the mixing and forwarding of the media information. One or more client terminals 106-1-m may join a conference by connecting to conferencing server 102.

In some cases, conferencing server 102 may have certain bandwidth constraints, such as a total output bit rate budget that it can use to send media information. The total output bit rate budget may sometimes be referred to generically as its output capacity. Since conferencing server 102 sends out or reflects many output data streams at any given time from multiple participants and multiple conference calls, its output capacity must be shared between the different output data streams.

In some cases, each output data stream has a fixed, constant bit rate, and hence the number of output streams that can be supported by a conferencing server is at most its output capacity divided by the bit rate of each output stream. This limits the total number of participants in simultaneous conference sessions that a conferencing server can support. Admission control techniques are traditionally used to block establishment of sessions that would put a conferencing server over its capacity.

Unfortunately, this traditional approach makes inefficient use of the output capacity for a conferencing server. This is because some data streams are more compressible than others. For example, the video of a slowly moving participant with a solid shirt is likely to be more compressible (e.g., take fewer bits to encode) than a video of an actively moving participant with a checkered shirt, for similar levels of perceived quality. Furthermore, the instantaneous compressibility of a data stream can change over time due to changes in content matter. Variable bit rate coding is one way to allow each data stream to use more or fewer bits over time as necessary to represent the data to a reasonable level of fidelity. Variable bit rate coding enables the average bit rate of a data stream to be reduced, for the same level of quality. Fluctuations of the instantaneous bit rate about the average are hard to predict for a single data stream, but when there are a large number of data streams, the law of large numbers makes the total bit rate fairly predictable. In this way, a conferencing server can employ statistical multiplexing to make more efficient use of its output capacity.

Even with statistical multiplexing of a large number of data streams, however, it is still possible to exceed the capacity due to random fluctuations in video content. Thus a conferencing server will still admit fewer participants than the average bit rate of a data stream divided into its capacity. The more aggressively a conferencing server admits new participants, pushing the average overall bit rate closer to its capacity, the more likely the capacity will be occasionally exceeded. Thus a conferencing server cannot be too aggressive in admitting participants, and even when it is aggressive, does not necessarily make full use of its capacity.

Various embodiments may attempt to solve these and other problems by improving efficient utilization of the computing and/or communication resources available to conferencing server 102. More particularly, various embodiments may attempt to implement rate matching techniques to selectively reduce a bit rate for one or more input video streams to stay within a bandwidth constraint for conferencing server 102, such as its the output bit rate budget or output capacity.

In one embodiment, for example, an apparatus such as conferencing server 102 may include a receiver arranged to receive input video streams at first bit rates from multiple client terminals 106-1-m. Conferencing server 102 may further include a rate management module 104. Rate management module 104 may include a rate allocation module and a video transrating module. Video transrating module may include a video encoder and a video transcoder.

In operation, the rate allocation module may be arranged to allocate an output bit rate for an output video stream corresponding to each input video stream based on distortion rate information. The distortion rate information may be sent with each video stream as side information. The rate allocation module may allocate the output bit rates for the output video streams using an output bit rate allocation technique that ensures that a total output bit rate for all output video streams is equal to or less than a total output bit rate budget for conferencing server 102. Depending upon the type of input video stream received by conferencing server 102, the video transrating module may use the video encoder and/or video transcoder to reduce the first bit rate to a second bit rate for each input video stream in accordance with the allocations to create the output video streams.

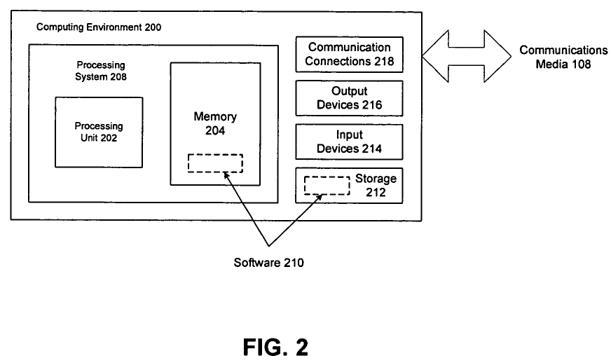

FIG. 2 illustrates a block diagram of computing environment 200. Computing environment 200 may be implemented as a device, or part of a device, such as conferencing server 102 and/or client terminals 106-1-m. In some embodiments, computing environment 200 may be implemented to execute software 210. For example, when computing environment 200 is implemented as part of conferencing server 102, software programs 210 may include rate management module 104 and accompanying components and data. Software programs 210 may also include other software programs to implement different aspects of conferencing server 102 as well, such as various types of conference call software, operating system software, application programs, video codecs, video transcoders, audio codecs, security software, call control software, gatekeeper software, multipoint controllers, multipoint processors, and so forth. Alternatively such operations may be implemented in the form of dedicated hardware (e.g., DSP, ASIC, FPGA, and so forth) or a combination of hardware, firmware and/or software as desired for a given implementation. The embodiments are not limited in this context.

In its most basic configuration, computing environment 200 typically includes a processing system 208 that comprises at least one processing unit 202 and memory 204. Processing unit 202 may be any type of processor capable of executing software, such as a general-purpose processor, a dedicated processor, a media processor, a controller, a microcontroller, an embedded processor, a digital signal processor (DSP), and so forth. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information.

As shown in FIG. 2, memory 204 may store multiple copies or versions of software programs 210, such as rate management module 104 and accompanying data, at varying points in time. In some cases, such as for rate management module 104, software programs 210 may have to be duplicated in the memory if it is designed to handle more than one video stream at a time. Likewise, processor 202 and rate management module 104 may be duplicated several times if the host system is a multi-core microprocessor-based computing platform. The embodiments are not limited in this context.

Computing environment 200 may also have additional features and/or functionality beyond configuration 208. For example, computing environment 200 may include storage 212, which may comprise various types of removable or non-removable storage units. Storage 212 may be implemented using any of the various types of machine-readable or computer-readable media as previously described. Computing environment 200 may also have one or more input devices 214 such as a keyboard, mouse, pen, voice input device, touch input device, and so forth. One or more output devices 216 such as a display device, speakers, printer, and so forth may also be included in computing environment 200 as well.

Computing environment 200 may further include one or more communications connections 218 that allow computing environment 200 to communicate with other devices via communication links 108-1-n. Communications connections 218 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes both wired communications media and wireless communications media, as previously described. The terms machine-readable media and computer-readable media as used herein are meant to include both storage media and communications media.

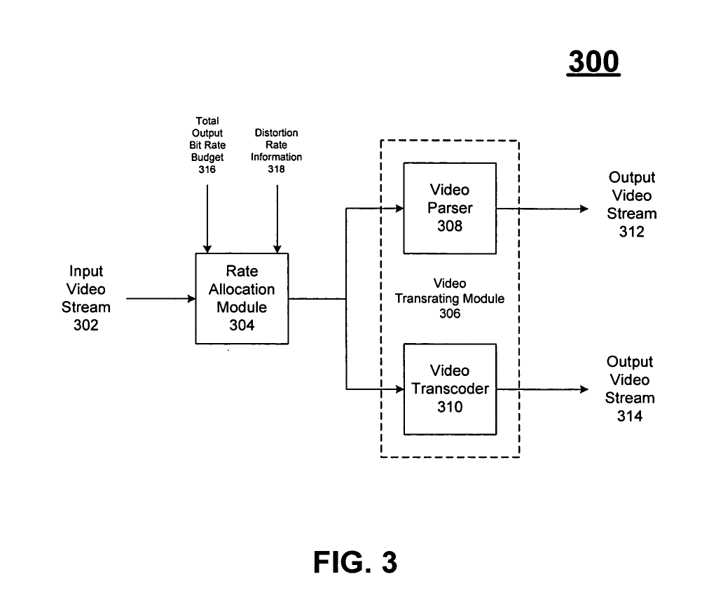

In various embodiments, computing environment 200 may be implemented as part of conferencing server 102. In particular, computing environment 200 may be implemented with software programs 210 to include rate management module 104. Rate management module 104 may be arranged to perform rate management operations for conferencing server 102. For example, rate management module 104 may attempt to selectively and dynamically reduce a bit rate for one or more input video streams to generate output video streams that fit within a total output bit rate budget for conferencing server 102. The structure and operations for rate management module 104 may be described in more detail with reference to FIG. 3.

FIG. 3 illustrates an embodiment of rate management module 104 suitable for use with conferencing server 102. As shown in FIG. 3, rate management module 104 may include a rate allocation module 304 and a video transrating module 306. Video transrating module 306 may further include a video parser 308 and a video transcoder 310. More or less modules may be implemented for rate management module 104 to perform the same number of overall operations for rate management module 104 as desired for a given implementation. The embodiments are not limited in this context.

Rate management module 104 may perform rate management operations on behalf of conferencing server 102 to improve efficient utilization of the total output bit rate budget for conferencing server 102. In various embodiments, assume each client terminal 106-1-m that sends a video stream to conferencing server 102 encodes the data stream such that each frame (or group of frames) is independently scalable, and contains distortion rate information as side information. The distortion rate information is a representation of a function D(R), representing the distortion or conversely the quality of the frame as a function of the number of bits used to encode the frame.

In various embodiments, rate management module 104 of conferencing server 102 generally examines the distortion rate information associated with the current frame of each outgoing data stream and allocates bits to the outgoing data streams in accordance with the distortion rate information. In some cases, rate management module 104 may weight the distortion rate information based on other factors or criteria. An example of weighting operations may include multiplying the distortion component by the importance or priority level of a given video stream.

In various embodiments, the output bit rate allocation algorithm may be designed to allocate bits in increments. The size of each increment is variable, and may have a granularity of one bit at a time, for example. Rate management module 104 assigns each increment to the outgoing data stream that has the greatest decrease in distortion or increase in quality per bit, up to the maximum number of bits that can be allocated for that frame. The number of bits that can be allocated is limited by one or more assignment limitation parameters, including: (1) the number of bits to which the frame was originally encoded; (2) the maximum bit rate supportable by a client terminal 106-1-m consuming the outgoing data stream; and (3) the maximum overall output bit rate supportable by conferencing server 102 (e.g., its output capacity). This process stops when no more bits can be allocated to any outgoing data streams. Then the process is repeated for the next frame or group of frames.

Alternatively, rate management module 104 may directly assign to each outgoing data stream a bit rate R, representing a number of bits per frame (or per group of frames) for that data stream, such that if R is less than the maximum bit rate supportable by a client terminal 106-1-m consuming the outgoing data stream, and less than the number of bits to which the frame (or group of frames) was originally encoded, then at bit rate R the slope of the distortion rate function D(R) for that data stream must be equal to a number λ, which is constant across all data streams. The constant λ can be iteratively adjusted until the sum of the bit rates across all data streams is maximized, yet is at most the output capacity of conferencing server 102. This is referred to as allocation by matching slopes of the distortion rate functions.

In general operation, a receiver such as communication connection 218 may receive input video streams 302 at first bit rates from multiple client terminals 106-1-m. Communication connection 218 may forward input video streams 302 to rate management module 104. Rate allocation module 304 of rate management module 104 may receive input video streams 302. Alternatively, rate allocation module 304 may be removed from the processing path, and input video streams 302 may be input directly to video transrating module 306.

Rate allocation module 304 may receive or determine a total output bit rate budget value 316 for conferencing server 102. Total output bit rate budget value 316 may represent at total output bit rate budget available for a given communication connection 218 used by conferencing server 102. Total output bit rate budget value 316 may be static and stored in memory units 204, 212, or may be dynamic and calculated on a periodic or aperiodic basis to reflect current traffic loads for conferencing server 102 and/or communication links 108-1-n.

Rate allocation module 304 may also receive distortion rate information 318 for each input video stream 302. Rate distortion theory attempts to determine the minimal amount of entropy or information R that should be communicated over a channel, so that the source input signal can be reconstructed at the receiver output signal with a given distortion D. Rate distortion theory gives theoretical bounds for how much compression can be achieved using lossy data compression methods. Many of the existing audio, speech, image, and video compression techniques have transforms, quantization, and bit-rate allocation procedures that capitalize on the general shape of rate-distortion functions. In rate distortion theory, the rate is usually understood as the number of bits per data sample to be stored or transmitted. The distortion is typically defined as the variance of the difference between input and output signal, such as the mean squared error of the difference. In some cases, other distortion measures are used that include various aspects of human perception. In image and video compression, for example, the human perception models may include the Joint Photographic Expert Group (JPEG) and Moving Picture Expert Group (MPEG) weighing (quantization, normalization) matrix.

In various embodiments, distortion rate information 318 includes any metric used to determine a given value for D(R). In some embodiments, distortion rate information 318 may be retrieved as in-band or out-of-band information encoded with each input video stream 302. In other embodiments, distortion rate information 318 may be directly measured from communication links 108-1-n by various elements of conferencing server 102, such as a receiver, base band processor, application processor, and so forth. In yet other embodiments, distortion rate information 318 may be derived using historical information stored or programmed in memory units 204, 212. The embodiments are not limited in this context.

Once rate allocation module 304 receives total output bit rate budget value 316 and distortion rate information 318, rate allocation module 304 may allocate an output bit rate for an output video stream corresponding to each input video stream. Rate allocation module 304 may perform such allocations based on distortion rate information 316. Rate allocation module 304 may also perform such allocations in a manner that ensures a total output bit rate for all output video streams is equal to or less than total output bit rate budget value 316.

In some cases, rate allocation module 304 may use other criteria in allocating individual output bit rates for the output video streams. In one embodiment, for example, rate allocation module 304 may weight distortion rate information 318 for each video stream by a priority level, a level of motion within a given input video stream 302, a level of spatial resolution for a given input video stream 302, a level of temporal resolution for a given input video stream 302, a level of quality as measured by a signal-to-noise-ratio (SNR), a level of subscription service, a security level, and so forth. The embodiments are not limited in this context.

In some embodiments, rate allocation module 304 may perform individual output bit rate allocation operations by matching slopes of the distortion rate functions, as previously described.

Once rate allocation module 304 performs individual output bit rate allocation operations, rate allocation module 304 may route input video streams 302 to video transrating module 306. In various embodiments, video transrating module 306 may include a video parser 308 and/or a video transcoder 310. Video parser 308 and/or video transcoder 310 may be used to reduce one or more input video streams 302 from a first bit rate to a second bit rate in accordance with the allocations set by rate allocation module 304 to create output video streams 312, 314. In some cases, the second bit rate is lower than the first bit rate, although not in all cases. The embodiments are not limited in this context.

If the input video stream 302 comprises a scalable video stream with multiple video layers of varying levels of spatial resolution, temporal resolution and/or quality, then video transrating module 306 may use scalable video parser 308. Video parser 308 may be arranged to parse out video layers or selectively remove some bits from the input video stream 302 in order to reduce the input bit rate to the allocated output bit rate.

If the input video stream is not scalable, however, then video transrating module 306 may use video transcoder 310 to reduce the input bit rates to the allocated output bit rates. Transcoding is the direct digital-to-digital conversion from one (usually lossy) codec to another. It involves decoding/decompressing the original data to a raw intermediate format in a way that mimics standard playback of the lossy content, and then re-encoding this into the target format. Examples of an intermediate format may include pulse code modulation for audio, or a YUV model which defines a color space in terms of one luminance (e.g., Y) and two chrominance components (e.g., U and V). The YUV model is used in Phase Alternation Line (PAL) systems and National Television Systems Committee (NTSC) systems of television broadcasting, which are fairly ubiquitous video standards used throughout much of the world. Transcoding can also refer to recompressing files to a lower bit rate without changing formats.

Referring again to FIG. 3, video transrating module 306 may be arranged to selectively reduce a first bit rate for one or more input video streams 302 to a second bit rate in conformance with the output bit rate allocations to create output video streams 312, 314. This may be accomplished in at least two ways. In a first case, for example, video transrating module 306 may determine whether an input video stream 302 is a scalable video stream or a non-scalable video stream. If the input video stream 302 is a scalable video stream, then video parser 308 of video transrating module 306 may remove one or more bits, blocks, macroblocks, video frames or other increments of video information from the scalable video stream to reduce the first bit rate to the second bit rate to form output video stream 312. If the input video stream 302 is a non-scalable video stream, then video transcoder 310 may transcode video information from the non-scalable video stream to reduce the first bit rate to the second bit rate to form output video stream 314. Output video streams 312, 314 may be multiplexed later in the processing path to facilitate communications by communication connection 218.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

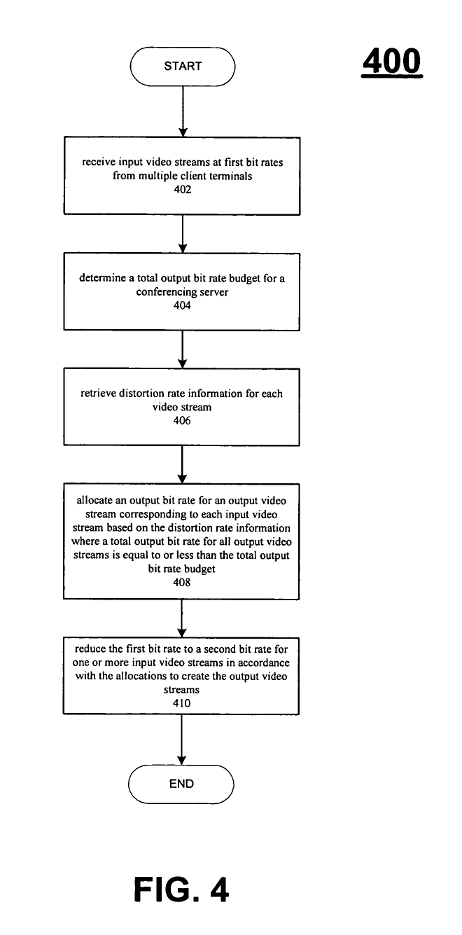

FIG. 4 illustrates one embodiment of a logic flow 400. Logic flow 400 may be representative of the operations executed by one or more embodiments described herein, such as multimedia conferencing system 100, conferencing server 102, rate management module 104, client terminal 106, and/or rate management module 104. As shown in FIG. 4, input video streams may be received at first bit rates from multiple client terminals at block 402. A total output bit rate budget for a conferencing server may be determined at block 404. Distortion rate information for each video stream may be retrieved at block 406. An output bit rate for an output video stream corresponding to each input video stream may be allocated based on the distortion rate information where a total output bit rate for all output video streams is equal to or less than the total output bit rate budget at block 408. The first bit rate may be reduced to a second bit rate for one or more input video streams in accordance with the allocations to create the output video streams. The embodiments are not limited in this context.

In one embodiment, for example, a video encoder may remove one or more video frames from a scalable video stream to reduce the first bit rate to the second bit rate. In one embodiment, for example, a video transcoder may transcode video information from a non-scalable video stream to reduce the first bit rate to the second bit rate. The embodiments are not limited in this context.

In one embodiment, for example, the distortion rate information for each video stream may be weighted by a priority level. The embodiments are not limited in this context.

In one embodiment, for example, a maximum number of bits that can be allocated for a video frame may be determined. An output video stream with a greatest decrease in distortion rate may be determined. The output video stream may be assigned increments of video information from the corresponding input video stream up to the maximum number of bits until an assignment limitation parameter is reached. The embodiments are not limited in this context.

In one embodiment, for example, the output video streams may be assigned increments of video information from the corresponding input video streams based on the distortion rate information and limited by a maximum number of bits for a video frame from the input video stream, a maximum bit rate supported by a client terminal to receive the output video stream, and/or the total output bit rate budget. The embodiments are not limited in this context.

In one embodiment, for example, an input video stream may be received having video information encoded with different video layers each with different levels of spatial resolution, temporal resolution and quality for a conference call. The input video stream may be encoded, for example, using a scalable video encoder or variable bit rate encoder, as well as others. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, computing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, CD-ROM, CD-R, CD-RW, optical disk, magnetic media, magneto-optical media, removable memory cards or disks, various types of DVD, a tape, a cassette, or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving input video streams at first bit rates from multiple client terminals;
determining a total output bit rate budget for a conferencing server;
retrieving distortion rate information for each video stream;
allocating an output bit rate for an output video stream corresponding to each input video stream based on said distortion rate information where a total output bit rate for all output video streams is equal to or less than said total output bit rate budget; and
reducing said first bit rate to a second bit rate for one or more input video streams in accordance with said allocations to create said output video streams.

2. The method of claim 1, comprising removing one or more video frames from a scalable video stream to reduce said first bit rate to said second bit rate.

3. The method of claim 1, comprising transcoding video information from a non-scalable video stream to reduce said first bit rate to said second bit rate.

4. The method of claim 1, comprising weighting said distortion rate information for each video stream by a priority level.

5. The method of claim 1, comprising:
determining a maximum number of bits that can be allocated for a video frame;
selecting an output video stream with a greatest decrease in distortion rate; and
assigning said output video stream increments of video information from said corresponding input video stream up to said maximum number of bits until an assignment limitation parameter is reached.

6. The method of claim 1, comprising assigning said output video streams increments of video information from said corresponding input video streams based on said distortion rate information and limited by a maximum number of bits for a video frame from said input video stream, a maximum bit rate supported by a client terminal to receive said output video stream, or said total output bit rate budget.

7. The method of claim 1, comprising receiving an input video stream having video information encoded with different video layers each with different levels of spatial resolution, temporal resolution and quality for a conference call.

8. An apparatus, comprising:
a receiver to receive input video streams at first bit rates from multiple client terminals;
a rate allocation module to allocate an output bit rate for an output video stream corresponding to each input video stream based on distortion rate information where a total output bit rate for all output video streams is equal to or less than a total output bit rate budget for a conference server; and
a video transrating module to reduce said first bit rate to a second bit rate for one or more input video streams in accordance with said allocations to create said output video streams.

9. The apparatus of claim 8, said video transrating module to include a video parser to remove one or more video frames from a scalable video stream to reduce said first bit rate to said second bit rate.

10. The apparatus of claim 8, said video transrating module to include a video transcoder to transcode video information from a non-scalable video stream to reduce said first bit rate to said second bit rate.

11. The apparatus of claim 8, said rate allocation module to weight said distortion rate information for each video stream by a priority level.

12. The apparatus of claim 8, said rate allocation module to determine a maximum number of bits that can be allocated for a video frame, select an output video stream with a greatest decrease in distortion rate, and assign said output video stream increments of video information from said corresponding input video stream up to said maximum number of bits until an assignment limitation parameter is reached.

13. The apparatus of claim 8, said rate allocation module to receive an input video stream having video information encoded with different video layers each with different levels of spatial resolution, temporal resolution and quality for a conference call.

14. The apparatus of claim 8, said receiver to receive an input video stream having video information encoded with different video layers including a base layer having a first level of spatial resolution and a first level of temporal resolution, and an enhancement layer increasing said first level of spatial resolution or said first level of temporal resolution.

15. An article comprising a machine-readable storage medium containing instructions that if executed enable a system to:
receive input video streams at first bit rates from multiple client terminals;
determine a total output bit rate budget for a conferencing server;
retrieve distortion rate information for each video stream;
allocate an output bit rate for an output video stream corresponding to each input video stream based on said distortion rate information where a total output bit rate for all output video streams is equal to or less than said total output bit rate budget; and
reduce said first bit rate to a second bit rate for one or more input video streams in accordance with said allocations to create said output video streams.

16. The article of claim 15, further comprising instructions that if executed enable the system to remove one or more video frames from a scalable video stream to reduce said first bit rate to said second bit rate.

17. The article of claim 15, further comprising instructions that if executed enable the system to transcode video information from a non-scalable video stream to reduce said first bit rate to said second bit rate.

18. The article of claim 15, further comprising instructions that if executed enable the system to weight said distortion rate information for each video stream by a priority level.

19. The article of claim 15, further comprising instructions that if executed enable the system to:
determine a maximum number of bits that can be allocated for a video frame;
select an output video stream with a greatest decrease in distortion rate; and
assign said output video stream increments of video information from said corresponding input video stream up to said maximum number of bits until an assignment limitation parameter is reached.

20. The article of claim 15, further comprising instructions that if executed enable the system to assign said output video streams increments of video information from said corresponding input video streams based on said distortion rate information and limited by a maximum number of bits for a video frame from said input video stream, a maximum bit rate supported by a client terminal to receive said output video stream, or said total output bit rate budget.

21. The article of claim 15, further comprising instructions that if executed enable the system to receive an input video stream having video information encoded with different video layers each with different levels of spatial resolution, temporal resolution and quality for a conference call.
